(19) United States
(12) Patent Application Publication
(10) Pub. No.: US 2014/0065702 A1
(43) Pub. Date: Mar. 6, 2014

(54) POLYMERASE CHAIN REACTION

(71) Applicant: INDUSTRIAL TECHNOLOGY RESEARCH INSTITUTE, Hsinchu (TW)

(72) Inventors: Jane SC TSAI, Taipei City (TW); Nikolay SERGEEV, Foster City, CA (US); Chih-Hsiang SUNG, Hsinchu County (TW); Tseng-Huang LIU, Kaohsiung City (TW); Ting-Hsuan CHEN, Taipei City (TW)

(21) Appl. No.: 13/902,060

(22) Filed: May 24, 2013

Related U.S. Application Data
(60) Provisional application No. 61/651,848, filed on May 25, 2012.

(51) Int. Cl. B01L 7/00

(52) U.S. Cl. CPC B01L 7/52
USPC 435/286.1

(57) ABSTRACT

A polymerase chain reaction (PCR) device for a reverse transcriptase reaction (RT) and a convectively-driven polymerase chain reaction (cPCR) in the same device is provided. The PCR device comprises an upper temperature-controlling unit, a middle temperature-controlling unit and a lower temperature-controlling unit. The middle temperature-controlling unit is used for controlling a temperature of a reaction mixture contained in a reaction container to have a temperature for the reverse transcriptase reaction. The middle temperature-controlling unit is disposed between the upper temperature-controlling unit and the lower temperature-controlling unit. The upper temperature-controlling unit and the lower temperature-controlling unit are used for simultaneously controlling the reaction mixture contained in the reaction container to have a temperature gradient and a convection condition for the convectively-driven polymerase chain reaction.

This application claims the benefit of U.S. provisional application Ser. No. 61/651,848, filed May 25, 2012, the subject matter of which is incorporated herein by reference.

### TECHNICAL FIELD

The disclosure relates in general to a polymerase chain reaction (PCR) device.

### BACKGROUND

Polymerase chain reaction (PCR) is a molecular biological technology for amplifying a particular DNA fragment. Normally, the PCR performs thermal cycling step repeatedly on a reaction mixture between 2 or 3 temperatures.

Reverse transcriptase-polymerase chain reaction (RT-PCR) refers to generating complementary DNA from an RNA template (that is, RT), and further using the complementary DNA as a template for performing PCR to duplicate and amplify DNA (that is, PCR). Through the said reaction, the response rate and accuracy in biochemical tests and specimen sampling are greatly increased. Convectively-driven polymerase chain reaction (cPCR) is one type of PCR used for generating convection-type thermal cycling on the reaction mixture to perform the amplification of the reaction mixture.

However, the reverse transcriptase-convectively-driven polymerase chain reaction (RT-cPCR) requires different and separate devices, not only reducing reaction efficiency but also bearing the risk to generate a false positive result due to the contamination problem caused by multi-switching of the device.

### SUMMARY

The disclosure is directed to a polymerase chain reaction (PCR) device for performing a reverse transcriptase reaction (RT) and a convectively-driven polymerase chain reaction (cPCR) on a sample in the same device.

According to one embodiment of the present disclosure, a polymerase chain reaction (PCR) device for performing a reverse transcriptase reaction (RT) and a convectively-driven polymerase chain reaction (cPCR) is provided. The PCR device comprises an upper temperature-controlling unit, a middle temperature-controlling unit and a lower temperature-controlling unit.

The middle temperature-controlling unit is used for controlling a temperature of a reaction mixture contained in a reaction container to have a temperature for the reverse transcriptase reaction. The middle temperature-controlling unit is disposed between the upper temperature-controlling unit and the lower temperature-controlling unit. The upper temperature-controlling unit and the lower temperature-controlling unit are used for simultaneously controlling the reaction mixture contained in the reaction container to have a temperature gradient and a convection condition for the convectively-driven polymerase chain reaction.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 is a polymerase chain reaction (PCR) device according to an embodiment.

FIG. 2 is a PCR device according to another embodiment.

FIG. 3 is a result of colloid electrophoresis obtained by performing a reverse transcriptase reaction (RT) and a convectively-driven polymerase chain reaction (cPCR) by a PCR device of the present disclosure according to an alternate embodiment.

### DETAILED DESCRIPTION

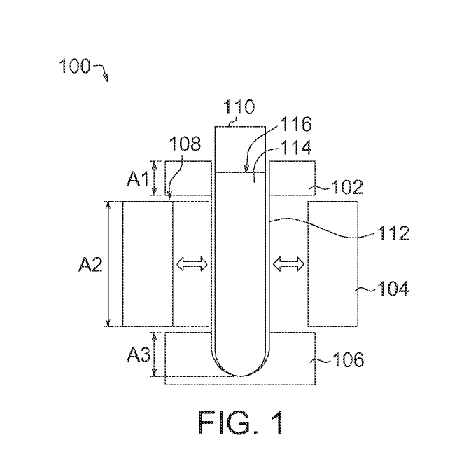

Referring to FIG. 1, a polymerase chain reaction (PCR) device 100 according to an embodiment of the present disclosure is shown. The PCR device 100 is for performing a reverse transcriptase reaction (RT) and a convectively-driven polymerase chain reaction (cPCR). The PCR device 100 comprises an upper temperature-controlling unit 102, a middle temperature-controlling unit 104 and a lower temperature-controlling unit 106. The middle temperature-controlling unit 104 is disposed between the upper temperature-controlling unit 102 and the lower temperature-controlling unit 106.

The upper temperature-controlling unit 102, the middle temperature-controlling unit 104 and the lower temperature-controlling unit 106 can be independently designed to have heating function and/or heat dissipating function according to actual needs. In an embodiment, the upper temperature-controlling unit 102, the middle temperature-controlling unit 104 and the lower temperature-controlling unit 106 can be made of a material having excellent thermal conductivity such as aluminum, aluminum alloy, copper, red copper, etc. For example, the heating function can be achieved by way of heat conduction (for example generated by electrical heat energy or magnetic heat energy, etc), heat conduction or thermal convection (for example generated by air or fluid heat energy, etc), thermal radiation (for example generated by infrared heat energy, carbon tube heat energy or laser energy, etc) or a combination thereof for enabling the upper temperature-controlling unit 102, the middle temperature-controlling unit 104 and the lower temperature-controlling unit 106 to accumulate heat energy. The heat dissipating function can be achieved by a way of heat sink, fan, thermoelectric cooling module, heat pipe, flat heat pipe or a combination thereof. The upper temperature-controlling unit 102, the middle temperature-controlling unit 104 and the lower temperature-controlling unit 106 can be realized in a form of film, block or other shapes. For example, the upper temperature-controlling unit 102, the middle temperature-controlling unit 104 and the lower temperature-controlling unit 106 may comprise a film resistance heater or a Peltier element using a metal or alloy block as an electrical connecting element. The upper temperature-controlling unit 102, the middle temperature-controlling unit 104 and the lower temperature-controlling unit 106 can sense a temperature independently by a temperature sensor such as a thermal couple.

The upper temperature-controlling unit 102, the middle temperature-controlling unit 104 and the lower temperature-controlling unit 106 are separated from each other by a gap 108. The upper temperature-controlling unit 102, the middle temperature-controlling unit 104 and the lower temperature-controlling unit 106 are thermally isolated from each other. The effect of thermal isolation can be achieved by adjusting a size of the gap 108 and/or a material for filling the gap 108, and/or other factors. The gap 108 may be filled with a vacuum, a gas (for example comprising air) or an insulating solid. The insulating solid can be disposed on opposite surfaces of the upper temperature-controlling unit 102, the middle temperature-controlling unit 104 and the lower temperature-controlling unit 106, and can be made of a material having low thermal conductivity such as a phenol formaldehyde resin, a plastic, Teflon or a polyurethane or other suitable materials such as materials used in a printed circuit board.

In an embodiment, the upper temperature-controlling unit 102, the middle temperature-controlling unit 104 and the lower temperature-controlling unit 106 are designed to have a recess 112 capable of accommodating a reaction container 110 such as a tube. The recess 112 can have any shapes. The recess 112 can have any aspect ratio. For example, the aspect ratio of the recess 112 is less than or equal to 10. The recess 112 can be designed to have a cross-section view with a shape and a size similar to that of the reaction container 110, such that the upper temperature-controlling unit 102, the middle temperature-controlling unit 104 and the lower temperature-controlling unit 106 can lean on the reaction container 110 to effectively transfer the heat and reduce the loss of energy. The reaction container 110 can be made of a material comprising a plastic, a quartz, a glass, a ceramic, a metal, etc.

In an embodiment, a ratio of temperature-controlling areas of the upper temperature-controlling unit 102, the middle temperature-controlling unit 104 and the lower temperature-controlling unit 106 for the recess 112 are appropriately designed such that the PCR can be effectively performed to the reaction mixture 114 contained in the reaction container 110. For example, a temperature-controlling area A1 of the upper temperature-controlling unit 102 for a lower portion of the recess 112: a temperature-controlling area A2 of the middle temperature-controlling unit 104 for a middle portion of the recess 112: a temperature-controlling area A3 of the temperature-controlling unit 106 for a lower portion of the recess 112 is 3˜5:10˜13:3˜5. When an area of the cross-section view of the recess 112 is uniform, the ratio between the temperature-controlling areas A1, A2 and A3 is equivalent to a ratio between heights of the temperature-controlling units. A volume of the reaction mixture 114 contained in the reaction container 110 may be between 50 μl˜150 μl, such as 75 μl. The size is not limited to the above exemplification, and can be adjusted according to actual needs. The reaction mixture 114 contains ordinary reagents and compounds used in the reverse transcriptase reaction and the cPCR.

Referring to FIG. 1., before the reverse transcriptase reaction is performed, the middle temperature-controlling unit 104 can be moved to be close to the reaction container 110 and the recess 112. The middle temperature-controlling unit 104 can be used for controlling the reaction mixture 114 contained in the reaction container 110 to have a temperature needed for the reverse transcriptase reaction, and the temperature can achieve an isothermal temperature so that the reverse transcriptase reaction can be performed. In an embodiment, the reverse transcriptase reaction can be achieved through setting only the middle temperature-controlling unit 104. Therefore, the middle temperature-controlling unit 104 can be regarded as a reverse transcriptase reaction unit. In the meantime, the upper temperature-controlling unit 102 and the lower temperature-controlling unit 106 stop functioning. In other words, the upper temperature-controlling unit 102 and the lower temperature-controlling unit 106 do not perform the heating and dissipating function. For example, a temperature of the middle temperature-controlling unit 104 used as a heat source is set to be between 40° C.˜60° C. (such as 45° C.) for the reverse transcriptase reaction.

Referring to FIG. 1, after the reverse transcriptase reaction, the middle temperature-controlling unit 104 can be used as a heat dissipating (or cooling) unit, and can be moved away from the reaction container 110 or the recess 112 during or before the cPCR.

Referring to FIG. 1, in an embodiment, the upper temperature-controlling unit 102 and the lower temperature-controlling unit 106 are used for simultaneously controlling the reaction mixture 114 contained in the reaction container 110 to have a temperature gradient and a convection condition for the cPCR. In an embodiment, the lower temperature-controlling unit 106 used as a heat source unit is set at a higher temperature, for example between 95° C.˜98° C., such as 95° C., and the upper temperature-controlling unit 102 used as a heat dissipating (or cooling) unit is set at a lower temperature (for example between 45° C. and 75° C., such as 60° C. or 65° C.) lower than the temperature of the lower temperature-controlling unit 106, such that the reaction mixture 114 can have a temperature gradient increasing from a lower portion to an upper portion of the reaction mixture 114 for performing the cPCR. For example, when the upper temperature-controlling unit 102 and the lower temperature-controlling unit 106 are respectively set at fixed temperatures, the reaction mixture 114 can obtain a constant temperature gradient and convection condition. In an embodiment, the upper temperature-controlling unit 102 is used for monitoring a temperature of an upper surface 116 of the reaction mixture 114 corresponding to the upper temperature-controlling unit 102, and can thus be regarded as a controlling unit for interface temperature.

In another embodiment, the upper temperature-controlling unit 102, the lower temperature-controlling unit 106 and the middle temperature-controlling unit 104 can be simultaneously set at temperatures required for performing the reverse transcriptase reaction. After the reverse transcriptase reaction is completed, the upper temperature-controlling unit 102 and the lower temperature-controlling unit 106 are directly set to temperatures for the cPCR from the temperatures for the reverse transcriptase reaction (that is, the upper temperature-controlling unit 102 and the lower temperature-controlling unit 106 perform no cooling process), so as to perform the cPCR. Therefore, the response time is short and efficiency is high.

The PCR device 100 of the present disclosure realizes the implementation of performing the reverse transcriptase reaction and the cPCR by one single device. The operation method of the PCR device 100 is simple and does not require a movement of the reaction mixture 114 between different devices, hence avoiding being damaged or being polluted during the movement of the reaction mixture 114. Thus, accuracy of test is increased. The reverse transcriptase reaction and the cPCR can be consecutively performed at a very short interval of the time to reduce the total response time and increase the test rate. The design of the PCR device 100 is simple. For example, the PCR device 100 can be designed to have a small volume or even can be designed as a portable point-of-care device at a low cost.

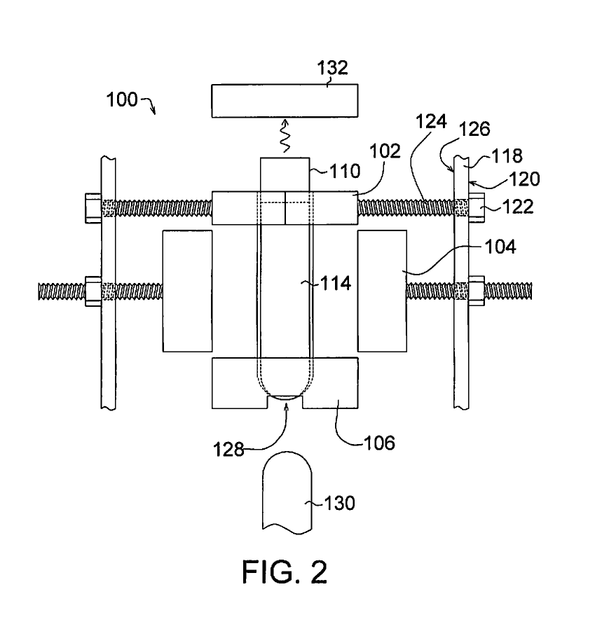

Referring to FIG. 2, a PCR device 100 according to another embodiment is shown. According to a mechanism, a length of a screw rod 124 on a side wall 126 of a supporting plate 118 is adjusted by rotating a screw nut 122 on a side wall 120 of the supporting plate 118 so as to control positions of the upper temperature-controlling unit 102 and the middle temperature-controlling unit 104 fixed at one end of the screw rod 124. In the present embodiment, the middle temperature-controlling unit can be moved through the said mechanism.

The PCR device 100 of the present disclosure can further integrate a real-time detector unit and elements used for a real-time PCR to form a 3-in-1 design of RT-PCR, cPCR, and real-time PCR.

FIG. 2 shows an exemplification of the PCR device 100 of the present disclosure integrated with the real-time detector unit and the elements used for the real-time PCR, but the method of integration is not limited thereto. The lower temperature-controlling unit 106 can have a transparent optical window 128 such as a hole or a lens to achieve the function of real-time monitoring. For example, the optical window 128 enables the light emitted by the lighting source 130 (such as a light emitting diode) disposed under the optical window 128 to pass through the reaction mixture 114 contained in the reaction container 110 (the reaction mixture 114 contains a fluorescent dye such as Sybr Green) and enter an optical sensor 132 (for example comprising a CCD or CMOS camera/image sensor). The accumulation of the PCR products can be determined in a real-time manner through the signal of light intensity, etc. An image can be sequentially captured in a movable manner or can be captured at a fixed point. A filter can be disposed between the lighting source 130 and the lower temperature-controlling unit 106. A filter can be disposed between the optical sensor 132 and the upper temperature-controlling unit 102.

In other embodiments, the device can be detected through other suitable design. For example, the lighting source (not illustrated) is disposed above the upper temperature-controlling unit 102, and the optical sensor (not illustrated) is disposed under the lower temperature-controlling unit 106. In other embodiments, the upper temperature-controlling unit 102 and the middle temperature-controlling unit 104 can be designed to have a transparent optical window (not illustrated).

The operation and design of the PCR device 100 can be adjusted according to actual needs (such as the reaction of other modes). For example, the PCR device 100 can be designed to have multiple reaction containers 110 such as an array of multiple test tubes to increase the overall detection rate. The upper temperature-controlling unit 102, the middle temperature-controlling unit 104 and the lower temperature-controlling unit 106 can respectively be designed as a movable temperature-controlling unit. The upper temperature-controlling unit 102, the middle temperature-controlling unit 104 and the lower temperature-controlling unit 106 can be moved by using a sliding block, an electromagnet and/or other suitable mechanical designs such as a spring. The PCR device 100 is not limited to the application in the cPCR, and can also be applied for an isothermal amplification reaction or other types of reaction.

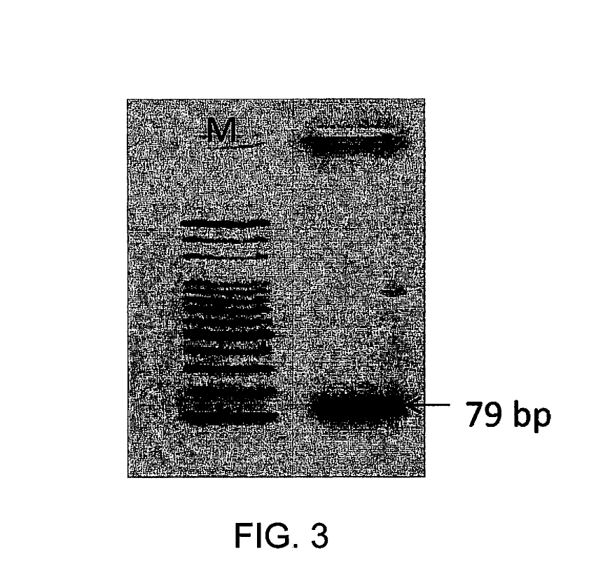

Referring to FIG. 3, the result of colloid electrophoresis obtained by performing the RT and the cPCR on β-actin mRNA of human by the PCR device of the present disclosure verifies that the single PCR device of the present disclosure can perform both the reverse transcriptase reaction and the cPCR.

In an embodiment, the PCR device 100 comprises the upper temperature-controlling unit 102, the middle temperature-controlling unit 104 and the lower temperature-controlling unit 106, and can be realized as a structure of multiple test tubes (such as in the form of an array).

While the disclosure has been described by way of example and in terms of the preferred embodiment (s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A polymerase chain reaction (PCR) device for a reverse transcriptase reaction (RT) and a convectively-driven polymerase chain reaction (cPCR), comprising:
a middle temperature-controlling unit used for controlling a temperature of a reaction mixture contained in a reaction container to be a temperature for the reverse transcriptase reaction;
an upper temperature-controlling unit; and
a lower temperature-controlling unit, wherein the middle temperature-controlling unit is disposed between the upper temperature-controlling unit and the lower temperature-controlling unit, and the upper temperature-controlling unit and the lower temperature-controlling unit are used for simultaneously controlling the reaction mixture contained in the reaction container to have a temperature gradient and a convection condition for the convectively-driven polymerase chain reaction.

2. The PCR device according to claim 1, wherein the upper temperature-controlling unit, the middle temperature-controlling unit and the lower temperature-controlling unit are separated from each other by a gap.

3. The PCR device according to claim 2, wherein the gap is filled with a material.

4. The PCR device according to claim 3, wherein the material for filling the gap comprises a vacuum, a gas, a phenol formaldehyde resin, a plastic, Teflon or a polyurethane.

5. The PCR device according to claim 1, wherein the upper temperature-controlling unit, the middle temperature-controlling unit and the lower temperature-controlling unit are disposed in a single chamber.

6. The PCR device according to claim 1, further comprising a recess for receiving the reaction container, wherein a temperature-controlling area of the upper temperature-controlling unit for the recess: a temperature-controlling area of the middle temperature-controlling unit for the recess: a temperature-controlling area of the lower temperature-controlling unit for the recess is 3˜5:10˜13:3˜5.

7. The PCR device according to claim 1, wherein the middle temperature-controlling unit is a movable temperature-controlling unit.

8. The PCR device according to claim 1, wherein the lower temperature-controlling unit is a heat source unit and the upper temperature-controlling unit is a heat dissipating unit for controlling the reaction mixture to have a temperature gradient increasing from a lower portion to an upper portion of the reaction mixture during the cPCR.

9. The PCR device according to claim 1, wherein when the middle temperature-controlling unit functions, the upper temperature-controlling unit and the lower temperature-controlling unit stop functioning or are set to have the same temperature as a temperature of the middle temperature-controlling unit.

10. The PCR device according to claim 1, wherein after the middle temperature-controlling unit stops the reverse transcriptase reaction, the lower temperature-controlling unit continues a heating-up function, and the upper temperature-controlling unit starts a heat-dissipation function to maintain the temperature gradient and the convection condition for the cPCR.

11. The PCR device according to claim 1, further comprising a real-time detector unit at least comprising a lighting source and an optical sensor, wherein the lighting source and the optical sensor are disposed in a manner that a light emitted from the lighting source can reach the optical sensor after passing through the reaction mixture contained in the reaction container.
